(19) United States
(12) Patent Application Publication
(10) Pub. No.: US 2006/0200840 A1
(43) Pub. Date: Sep. 7, 2006

(54) Structure for fixing optical pickup head mounting shaft

(75) Inventors: In Shuen Lee, Hsinchu (TW); Jung Fu Chen, Hsinchu (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/119,879

(22) Filed: May 3, 2005

(30) Foreign Application Priority Data
Mar. 1, 2005 (TW) 094106028

(51) Int. Cl. G11B 7/08; G11B 7/085; G11B 7/09

(52) U.S. Cl. 720/677

(57) ABSTRACT

A structure for fixing an optical pickup head mounting shaft includes a fixation seat on which a positioning groove and a restricting groove are disposed and a locking element locked in the restricting groove, in which one side of the positioning groove is formed with an opening to allow the shaft to be passed through the opening to positioned in the positioning groove. Whereby, the locking element is locked into the bottom of the restricting groove through the guidance of the wall of the restricting groove with a proper angle so that the locking element presses on the shaft properly and further provides the positioning function.

This Non-provisional application claims priority under 35 U.S.C. §119(a) on Patent Application No(s). 094106028 filed in Taiwan, Republic of China on Mar. 1, 2005, the entire contents of which are thereby incorporated by reference.

### FIELD OF THE INVENTION

The present invention relates to a structure for fixing an optical pickup head mounting shaft, and more particularly to a structure for fixing an optical pickup head mounting shaft effectively and preventing the shaft from being deviated when an external force is exerted thereon.

### DESCRIPTION OF RELATED ART

Please refer to FIG. 1, a conventional optical disc drive is shown. The conventional optical disc drive comprises an optical pickup head 1 used for reading the data recorded on an optical disc, a driving motor set 11 for driving the optical pickup head 1 to move, shafts 12, 13 used for mounting and guiding the optical pickup head 1 and a chassis 14, on which the driving motor set 11 and the shafts 12 and 13 are disposed. The optical pickup head 1 is driven by the driving motor set 11 to move along the shafts 12, 13 so as to repeatedly read the data recorded on an optical disc (not shown in the figure). Therefore, the relation between the plane constituted by the shafts 12 and 13 and the surface of the disc influences the reading quality of the optical disc drive greatly.

As the technology tends to become mature, the disc reading quality of a disc drive is demanded relatively higher. Therefore, an operator should adjust and correct the angle of the optical pickup head 1 or a spindle motor to allow laser light emitted from the optical pickup head is almost perpendicular to the surface of the disc to ensure the best disc reading quality.

However, the fixation structure of the shaft 13 used for mounting and guiding the optical pickup head in a conventional disc drive is shown in FIG. 2. A pair of positioning ribs 142 and a propping rib 143 are disposed on the chassis 14 in which a distance is kept between the positioning ribs 142 for accepting one end of shaft 13 and positioning them between the ribs 142 and the ends thereof to be propped against the propping ribs 143. Thereafter, a screw 15 is screwed beside the shaft 13 for allowing the rim of a screw head of the screw 15 to press the shaft 13 so that the shaft 13 is stably fixed between the positioning ribs 142. Besides, the fixation structure of the shaft 12 is the same with that of the shaft 13. Whereby, the optical pickup head can be moved to and fro on the shafts 12 and 13 to processing a track searching, focusing and reading the data recorded on the disc.

However, the manner for fixing the shafts 12 and 13 on the chassis 14 mentioned above has no structure capable of guiding the screw 15 to be screwed into the chassis 14 in a best angle so that the screw head is difficult to press the shaft 12 or 13 with a best angle at which the screw head presses and fixes the shaft 12 or 13 efficiently. Furthermore, when the disc drive is subjected to an external violent shock such as dropping or being thrown to the ground, the screws 15 may be easily deviated and could be unable to fix the shafts 12 and 13 efficiently. Therefore, the plane constituted by the shafts 12 and 13 is slanted and a laser beam emitted from the optical pickup head 1 is not projected on the surface of the disc vertically which causes a bad reading quality. And, the more serious is that the shafts 12 and 13 are accidentally released from the restriction of the screws 15 and even out of the space between the positioning ribs 142 causing the damage to the inner mechanism of the optical disc drive.

Besides, no matter what factors, such as a bad angle at which the screw 15 is screwed in the chassis 14, shock and collision, they may all easily cause the screws 15 to be deviated, because there is only a part of the screw head of the screw 15 pressing and fixing the shafts 12 and 13. Therefore, the fixing capability of the screws for fixing shafts may easily become bad and the reading quality of the disc drive also become worse.

### SUMMARY OF THE INVENTION

One object of the present invention is to provide a structure for fixing an optical pickup head mounting shaft, allowing a locking element used to fix the shaft to be locked in accurately with a best compressing angle for pressing the shaft efficiently.

Another object of the present invention is to provide a structure for fixing an optical pickup head mounting shaft, allowing a locking element used to fix the shaft to be kept continuously on the shaft in the best pressing angle to prevent the shaft from deviating or dropping from the chassis owing to the slanted deviation of the locking element.

For attaining to the objects mentioned above, a structure for fixing an optical pickup head mounting shaft according to the present invention comprises a fixation seat on which a positioning groove and a restricting groove are disposed in which one end of the shaft is accepted in the positioning groove and a locking hole is disposed at the bottom of the restricting groove, and a locking element accepted in the restricting groove and fixed in the locking hole at the bottom of the restricting groove. The locking element presses the shaft and fixes the shaft in the positioning groove. Furthermore, the locking element is fixed in the locking hole of the restricting groove at a proper angle through the guidance of the wall of the restricting groove so that it can press the shaft efficiently.

According to the present invention, the locking element is kept in the best pressing angle by the restriction of the wall of a restricting groove when an external shock is exerted on the shaft to lead to the concentration of the stress force on the locking element.

According to the present invention, the positioning groove and the restricting groove are communicated with each other, and the bottom of the positioning groove is lower than the one of the restricting groove such that the rim of the locking element can press against the end of the shaft to keep the end of the shaft in the positioning groove.

According to the present invention, a notch is disposed at the side wall of the positioning groove adjacent to the restricting groove for accepting the end of a shaft. And, the locking element presses on the shaft with the best angle to allow the end of the shaft to be positioned in the notch effectively when the locking element is locked into the locking hole through the guidance of the wall of the restricting groove.

According to the second referred embodiment of the present invention, a notch is disposed at the bottom of a positioning groove, and the fixing structure further includes an elastic element, in which the elastic element is accepted in the notch for supporting the shaft and providing as a suffer.

The shaft is supported on the elastic element when the locking element is locked into the fixing hole and presses on the end of the shaft. Therefore, an external impact can be absorbed by the elastic element to lessen the stress concentrated at the locking element effectively and prevent the locking element from slanting.

Furthermore, because the elastic element provides a compressible deformation space, the fixed height of the shaft can further be adjusted by the locking depth of the locking element locked into the locking hole to allow a laser beam emitted from a pickup head to project on the surface of the disc at an angle close to 90° to ensure the best reading quality.

### BRIEF DESCRIPTION OF THE DRAWINGS

The present invention can be more fully understood by reference to the following description and accompanying drawings, in which:

FIG. 1 is a bottom view of a conventional optical disc drive;

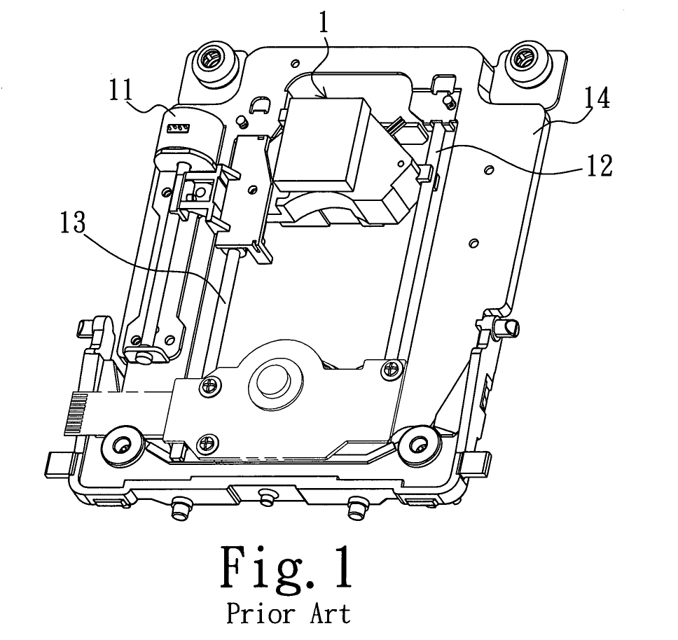

FIG. 2 is a top view of FIG. 1, showing an enlarged view a conventional shaft fixing structure;

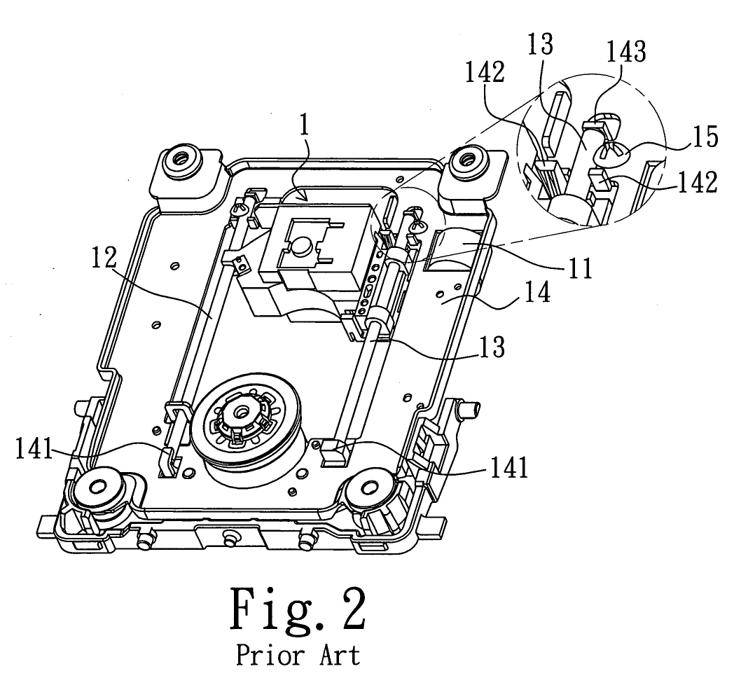

FIG. 3 is a perspective view, showing a structure for fixing an optical pickup head mounting shaft of a first preferred embodiment according to the present invention;

FIG. 4 is a partly enlarged view, showing a structure for fixing an optical pickup head mounting shaft of a first preferred embodiment according to the present invention;

FIG. 5 is cross sectional view, showing a fixation seat and a shaft in a structure for fixing an optical pickup head mounting shaft of a first preferred embodiment according to the present invention;

FIG. 6 is a perspective view, showing a structure for fixing an optical pickup head mounting shaft of a second preferred embodiment according to the present invention; and

FIG. 7 is cross sectional view, showing a fixation seat and a shaft in a structure for fixing an optical pickup head mounting shaft of a second preferred embodiment according to the present invention.

### DETAILED DESCRIPTION OF THE PREFERRED EMBODIMENTS

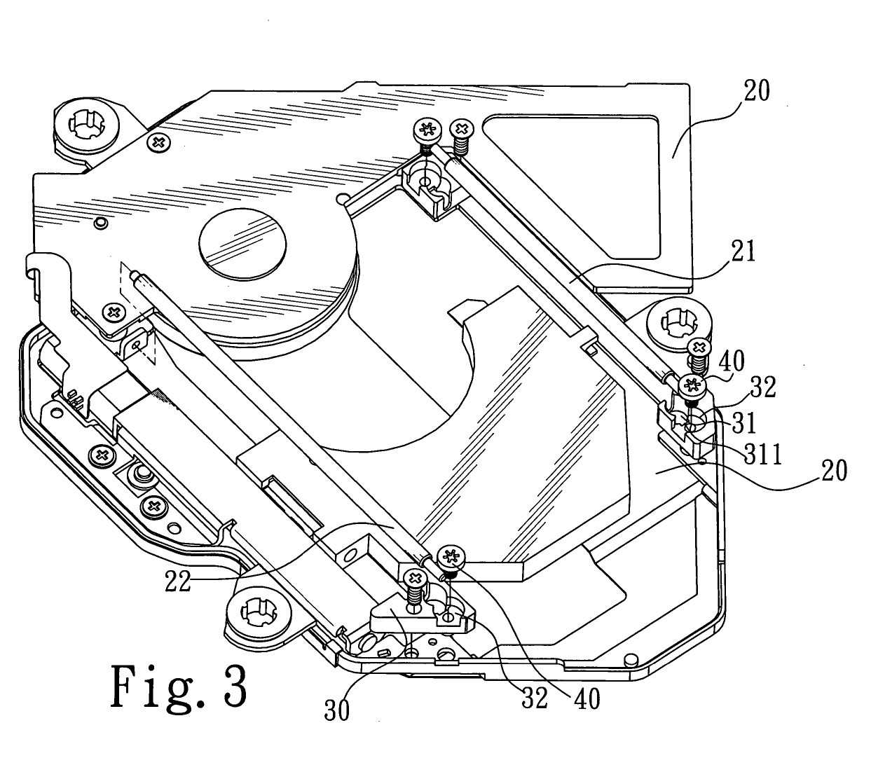

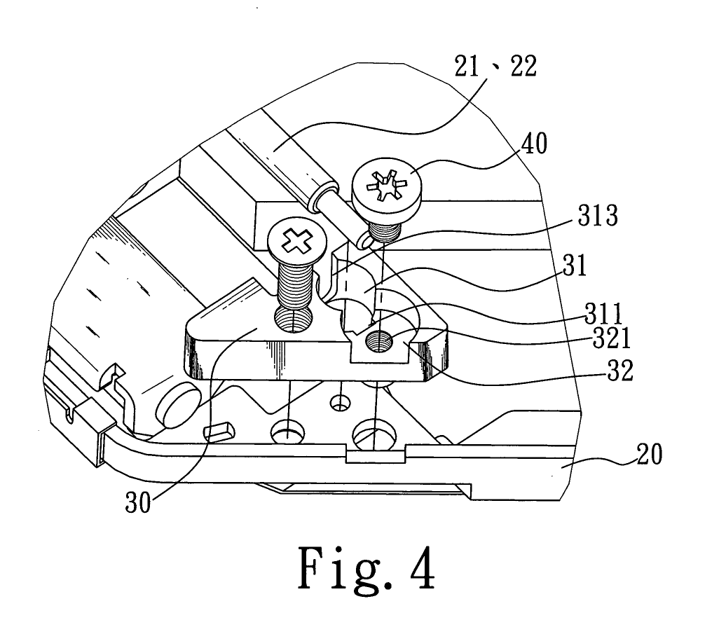

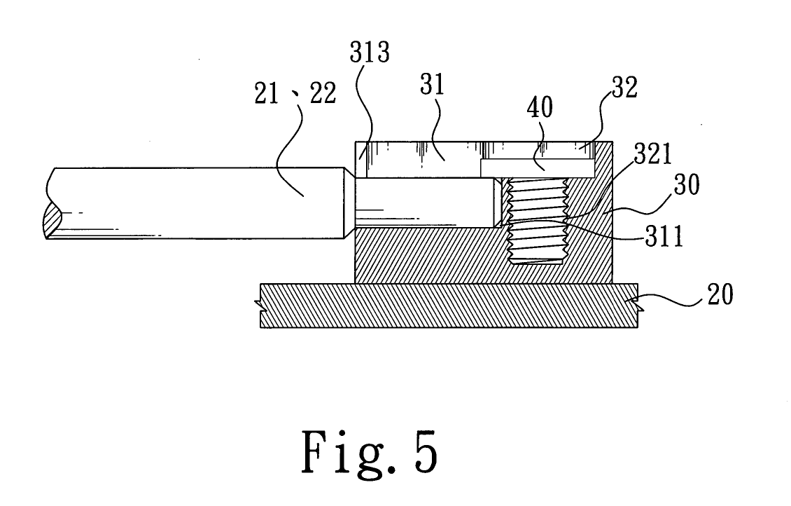

Please refer to FIGS. 3 to 5. FIGS. 3 to 5 respectively are perspective, partly enlarged and cross sectional views, showing a structure for fixing an optical pickup head mounting shaft of the first preferred embodiment according to the present invention. The fixing structure of the first preferred embodiment, as FIG. 3 shows, is disposed on at least one position of the chassis 20 where each end of shafts 21 and 22 are fixed. The fixing structure comprises a fixation seat 30 and a locking element 40. A position groove 31 and restricting groove 32, as FIG. 4 shows, are further respectively disposed on the fixation seat 30, in which an opening 313 is opened at one side of the wall of the positioning groove 31 to allow the shafts 21 and 22 being positioned in the positioning groove 31 through the opening 313. The restricting groove 32 is disposed at another side of the positioning groove 31 and the bottom thereof is little higher than the one of the positioning groove 31. A notch 311 is disposed on the wall at a side of the positioning groove 31 adjacent to the restricting groove 32 so that the end of either the shaft 21 or the shaft 22 can be guided to position in the notch 311, as FIG. 5 shows.

Besides, the locking element 40 is fixed into a locking hole 321 at the bottom of the restricting groove after the shafts 21 and 22 are positioned in the notches 311. Because the positioning groove 31 and the restricting groove 32 are communicated with each other, the rim of a locking element 40 is capable to press on the shafts 21 and 22 and fix the shafts stably in the positioning groove 31. According to the actual requirements of design, it may use more than one of the fixation seats 30 to fix the ends of the shafts 21 and 22. In the first preferred embodiment as shown in FIG. 3, there are three fixing structures for example.

Next, please refer to FIG. 5. Each end of the shafts 21 and 22 is only needed to be put into the positioning groove 31 through the opening 313 at the side of the fixation seat 30 and the end is fixed in the notch 311 when assembling the shafts 21 and 22 on the chassis 20. Thereafter, the locking element 40 is locked into a locking hole 321 at the bottom of the restricting groove 32. The locking element 40 is guided to lock into the locking hole 321 with a proper angle by the wall of the restricting groove 32, and then the locking element 40 properly presses on the shaft 21 or 22 and fixes the shaft 21 or 22. Therefore, the locking element can be allowed to press accurately on the shaft 21 or 22 with the best pressing angle according to the guidance of the wall of the groove mentioned above. The wall of the restricting groove 32 according to the present invention not only can guide the locking element 40 to be locked into the locking hole 321, but also can restrict the locking element 40 to be stably positioned in the restricting groove 32 to prevent it from being deviated due to the external shock. In the embodiment, the locking element 40 is a screw and the locking hole is a screw hole, but it is not limited to the collocation of the screw and the screw hole.

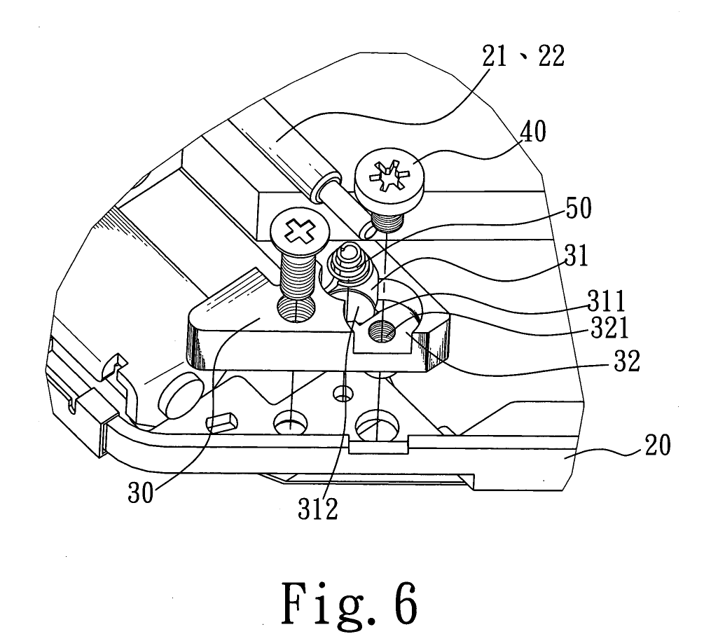

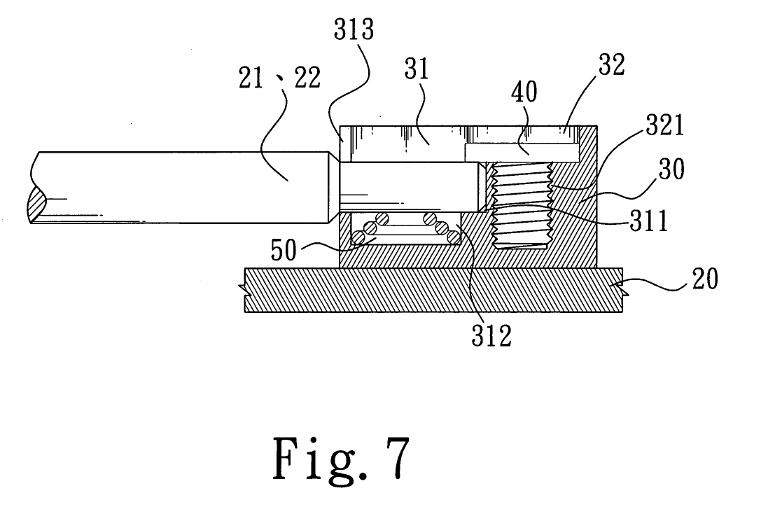

Please refer to FIGS. 6 and 7. FIGS. 6 and 7 are respectively perspective and cross sectional views, showing a structure for fixing an optical pickup head mounting shaft of a second preferred embodiment according to the present invention. As FIG. 6 shows, the structure of the fixing structure of the second preferred embodiment is similar to the one of the first preferred embodiment, the only difference is that a circular groove 312 is further disposed at the bottom of the fixation seat 30 and the fixing structure further comprises an elastic element 50. The elastic element 50 is accepted in the groove 312 for supporting the shaft 21 or 22 and provides as a buffer. The elastic element 50 in the embodiment is an element having the elastic character. For example, the elastic element 50 is a spring, a buffering pad or an elastic plastic sheet, and so on. In addition, although the groove 312 disposed at the bottom of the positioning groove 31 of the embodiment is circular, it can be any shape, only if the elastic element 50 can be accepted therein.

Next, please refer to FIG. 7. The shaft 21 or 22 is supported on the upper end of the elastic element 50 when the end of the shaft 21 or 22 is passed through the opening 313 formed at the side of the fixation seat 30 and disposed in the positioning groove 31. The locking element 40 is then locked into the locking hole 321 to press the end of the shaft 21 or 22, and the elastic element 50 is elastically deformed and compressed in the groove 312 by the shaft 21 or 22. Therefore, when a disc drive is exerted with an external shock, the elastic element 50 can function as a buffer for absorbing the force resulted from the external shock. Consequently, the stress transmitted to the locking element 40 can be reduced and the locking element 40 can be stably positioned in the restricting groove 32.

Besides, according to the deformation space formed by compressing the elastic element 50, the fixed height of the end of the shaft 21 or 22 can be adjusted by the locking depth of the locking element 40 locked in the locking hole 321 to allow laser light emitted from the optical pickup head 1 mounted on the shafts 21 and 22 is vertically projected onto the surface of a disc.

According to the present invention, the locking element can effectively be constrained in the restricting groove and will not be deviated easily by an external force. Therefore, it prevents the shafts from being loosened and even more the internal mechanisms in the disc drive are prevented from being damaged. In addition, the locking element can easily be locked into the locking hole with the best angle while assembling owing to the guidance of the wall of the restricting groove so that the assembly time and the production cost can be effectively reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A structure for fixing an optical pickup head mounting shaft, comprising:
a fixation seat on which a positioning groove and a restricting groove are disposed, one end of said shaft being accepted in said positioning groove and a locking hole being disposed at the bottom of said restricting groove; and
a locking element, accepted in said restricting groove and locked in said locking hole, said locking element pressing on said shaft to allow said shaft to be fixed in said positioning groove;
whereby, said locking element is guided by the inner wall of said restricting groove and locked into said locking hole with a proper angle.

2. The structure according to claim 1, wherein an opening is disposed at one side wall of said positioning groove for allowing said shaft to be positioned in said positioning groove through said opening.

3. The structure according to claim 1, wherein said positioning groove and said restricting groove are communicated with each other.

4. The structure according to claim 1, wherein the bottom of said positioning groove is lower than that of said restricting groove.

5. The structure according to claim 1, wherein a notch is disposed at the side wall of said positioning groove connected with said restricting groove for positioning the end of said shaft.

6. The structure according to claim 1, wherein a groove is further disposed at the bottom of said positioning groove and said structure further comprising an elastic element, which is accepted in said groove for supporting said shaft.

7. The structure according to claim 6, wherein said elastic element provides a stress buffering function.

8. The structure according to claim 1, wherein said locking element is a screw and said locking hole is a screw hole.
